(19) United States
(12) Patent Application Publication
(10) Pub. No.: US 2010/0066744 A1
(43) Pub. Date: Mar. 18, 2010

(54) Method and apparatus for triangle traversal process in graphic rasterization

(75) Inventors: Bai Xianghui, Shanghai (CN); Yasushi Sugama, Kanagawa (JP); Tan Zhiming, Shanghia (CN)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/461,554

(22) Filed: Aug. 14, 2009

(30) Foreign Application Priority Data
Aug. 29, 2008 (CN) 200810146771.6

(51) Int. Cl. G06T 11/20

(52) U.S. Cl. 345/441

(57) ABSTRACT

A method and apparatus for traversing a triangle in graphic rasterization are provided. The method includes creating a bounding box which is the smallest rectangle consisting of pixels that covers the triangle; choosing a traversal start pixel for traversing the triangle based on the bounding box; choosing a traversal direction based on the position relation between the traversal start pixel and the triangle; and traversing the triangle from the traversal start pixel in the traversal direction. The traversing the triangle includes calculating a next scan start pixel based on slope of a edge function of the triangle with respect to the traversal start pixel and the traversal direction.

### CROSS-REFERENCE TO RELATED APPLICATION

This application claims the benefit of Chinese Patent Application No. 200810146771.6, filed on Aug. 29, 2008 in the Chinese Intellectual Property Office, the disclosure of which is incorporated herein by reference.

### TECHNICAL FIELD

The invention relates generally to a method and apparatus for displaying an image. More specifically, the invention relates to a method and apparatus for triangle traversal process in graphic rasterization.

### BACKGROUND

The graphic rasterization is the procedure to convert the geometry primitives (line, triangle, polygon . . . ) into pixels for transmission to raster graphics displays. Triangle is the most important primitive in graphic rasterization for its useful properties: always convex, always reside in a simple plane and easy to create complex two-dimension primitives. The “triangle traversal” is the procedure to find all the pixels that are inside the triangle.

Edge functions are the fundamental to rasterizing triangle in hardware. The “edge functions” are three line functions of the three edges of a triangle, which are formed by the three vertices of triangle. The pixel inside the triangle has the property that three edge function values at this pixel are all positive or all negative. So edge functions are useful tool to decide whether a pixel is inside a triangle.

Many triangle traversal methods have been proposed based on edge functions. For example: Bounding box traversal, Backtrack traversal, and Zigzag traversal.

Above traversal algorithms are all scan-line based traversal methods. The basic idea of these is to create a bounding box of triangle and scan the bounding box following some orders.

### SUMMARY

In one aspect of the invention, a method for traversing a triangle in graphic rasterization is provided. The method comprises steps: creating a bounding box which is the smallest rectangle consisting of pixels that covers the triangle; choosing a traversal start pixel for traversing the triangle based on the bounding box; choosing a traversal direction based on the position relation between the traversal start pixel and the triangle; and traversing the triangle from the traversal start pixel in the traversal direction. The step for traversing the triangle comprises a step for calculating a next scan start pixel based on slope of a edge function of the triangle with respect to the traversal start pixel and the traversal direction.

In another aspect of the invention, an apparatus for traversing a triangle in graphic rasterization is provided. The apparatus comprises: a setup block 104 that receives vertex coordinates of the triangle, calculates coefficients of edge functions of the triangle by using the vertex coordinates, creates a bounding box of the triangle, chooses a traversal start pixel and a traversal direction; and a traverse block 105 that traverses the triangle based on the coefficients of edge functions, the traversal start pixel and the traversal direction. The traverse block 104 also calculates a next scan start pixel based on slope of a edge function of the triangle with respect to the traversal start pixel and the traversal direction.

The method and apparatus of the invention implement very fast and effective triangle traversal by not accessing pixels outside the triangle as much as possible in the traversal.

### BRIEF DESCRIPTION OF THE DRAWINGS

FIG. 1 is a block diagram of a system for drawing a triangle;

FIG. 2 is a flowchart generally showing a triangle traversal method according to the invention;

FIG. 3 shows the setup block 104 and traverse block 105 of the system shown in FIG. 1 in detail;

FIG. 4 shows an example of a bounding block of a triangle;

FIG. 5 is a flowchart showing a method for creating a bounding block of a triangle;

FIG. 6 shows the traversal start pixels each chosen in one of four different cases;

FIG. 7 is a flowchart showing a method for choosing the traversal direction;

FIGS. 8(a) and (b) show the traversal directions each chosen in one of two different cases;

FIG. 9 is an example showing a complete traversal of a triangle; and

FIG. 10 is a flowchart showing how to calculate the scan start pixel in the next scan line/column.

### DETAILED DESCRIPTION OF PREFERRED EMBODIMENTS

In the following description of the preferred embodiments, for the purpose of explanation, numerous specific details are set forth in order to provide a thorough understanding of the present invention. It will be apparent, however, to one skilled in the art that the present invention may be practiced without these specific details.

The efficiency of a triangle traversal method mainly depends on the redundant cost in visiting pixels that outside the triangle. Therefore, the objective of the presented invention is not to visit the pixels outside the triangle as much as possible.

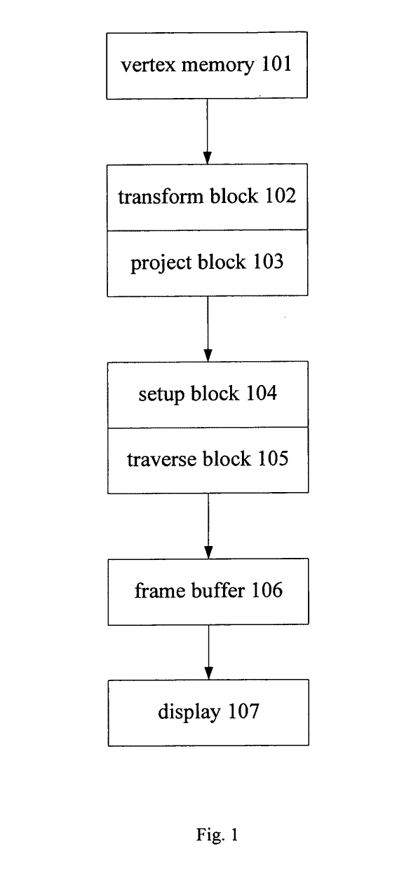

FIG. 1 is a block diagram of a system for drawing a triangle. The system comprises a vertex memory 101, a transform block 102, a project block 103, a setup block 104, a traverse block 105, a frame buffer 106 and a display 107.

Firstly, the vertex information (object coordinate) is read from vertex memory 101 into the transform block 102. The transform block 102 then transforms the vertex coordinates and the project block 103 projects the transformed vertex coordinates into device coordinates. The setup block 104 and traverse block 105 use the device coordinates to calculate which pixels are inside the triangle and calculate the parameters (for example, colour/texture) of these pixels. Then, the parameters are written into the frame buffer 106. The display 107 displays based on the contents written into the frame buffer 106.

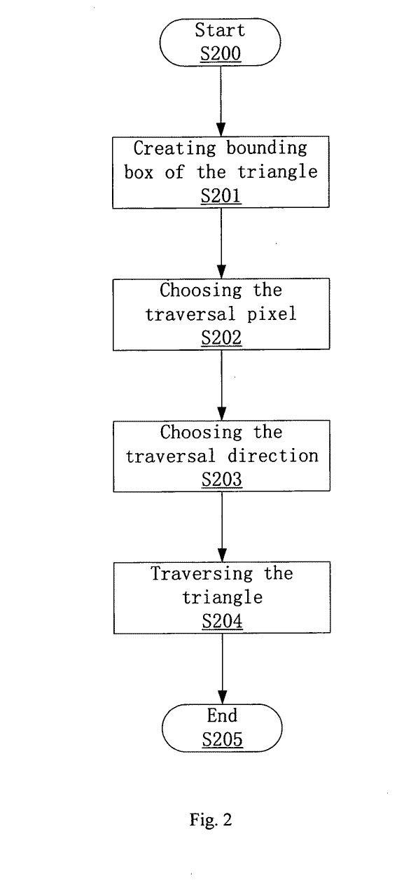

FIG. 2 is a flowchart generally showing a triangle traversal method according to the invention. The traversal method creates a bounding box at step S201, chooses a traversal start pixel at step S202, chooses a traversal direction at step S203 and then traverses the triangle at step S204.

Below, the method and apparatus for triangle traversal process will be described in detail.

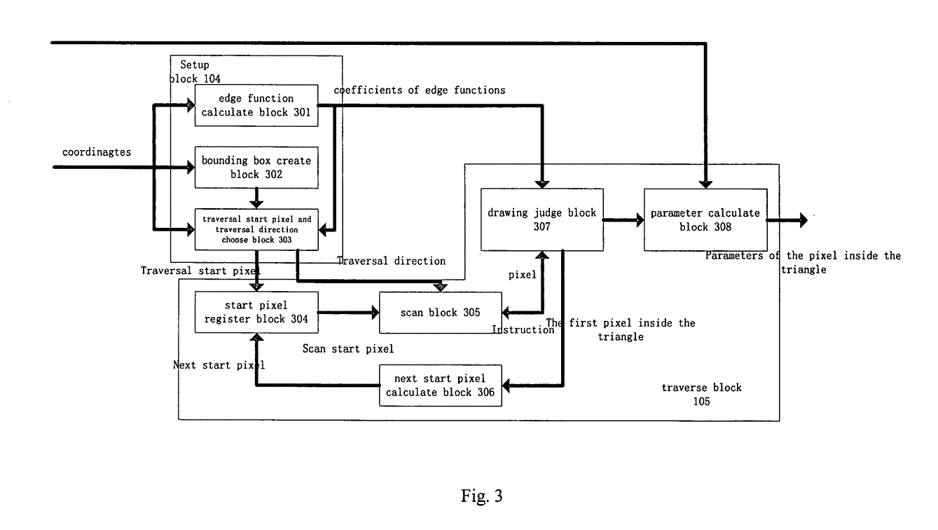

FIG. 3 shows the setup block 104 and traverse block 105 of the system shown in FIG. 1 in detail. The setup block 104 comprises an edge function calculate block 301, a bounding box create block 302, a traversal start pixel and traversal direction choose block 303. The traverse block 105 comprises a start pixel register block 304, a scan block 305, a next start pixel calculate block 306, a drawing judge block 307 and a parameter calculate block 308.

The edge function calculate block 301 in the setup block 104 receives from the project block 103 the coordinates of three vertexes of a triangle, V0 (x0, y0), V1 (x1, y1) and V2 (x2, y2). As for i=0, 1, 2, the (xi, yi) is a float value. In addition, the three vertexes V0, V1 and V2 are clockwise on the triangle. Based on the coordinates of the three vertexes, the edge function calculate block 301 calculates the edge functions of three edges of the triangle:

e0(x,y)=a0*x+b0*y+c0;

e1(x,y)=a1*x+b1*y+c1;

e2(x,y)=a2*x+b2*y+c2.

The bounding box create block 302 in the setup block 104 receives from the project block 103 the coordinates of three vertexes of the triangle, and creates the bounding box of the triangle by using the vertex coordinates. A bounding box of a triangle is the smallest rectangle consisting of pixels that covers the triangle, which is presented by coordinates of the pixels at the four corners of the rectangle (xmin, ymin), (xmin, ymax), (xmax, ymin) and (xmax, ymax).

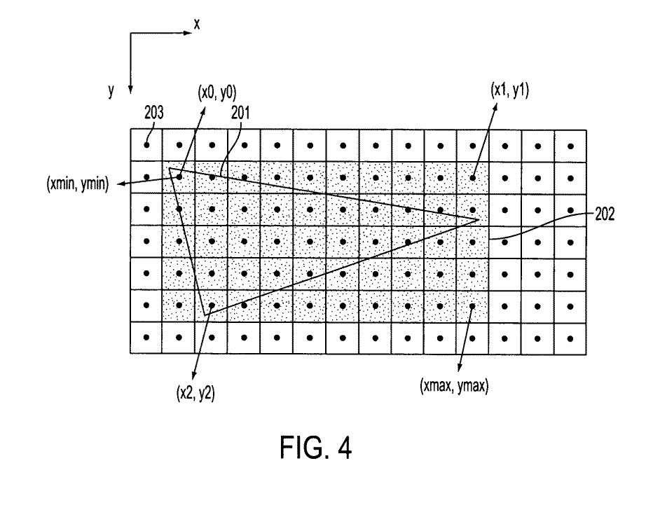

FIG. 4 shows an example of a bounding block of a triangle. Below, the process for creating the bounding box of a triangle is described with reference to the example shown in FIG. 4. The coordinates of three vertexes of the triangle 201 are (x0, y0), (x1, y1) and (x2, y2), respectively. From the coordinates of the three vertexes, the following intermediate values can be obtained:

fxmin = min (x0,x1,x2), fxmax = max(x0,x1,x2),
fymin = min (y0,y1,y2), fymax = max(y0,y1,y2),

wherein the functions min( ) and max( ) are used to calculate the minimum and maximum values of three variables therein, and all of fxmin, fxmax, fymin and fymax are float values.

Since the pixels 203 are located in integer coordinates, the above intermediate values will be converted into integer values by the following operations:

xmin = ceil(fxmin), xmax = floor(fxmax),
ymin = ceil(fymin), ymax = floor(fymax),

where the ceil (float a) function returns the minimum integer that is not less than a. For example, ceil (1.5)=2. The floor (float a) function returns the maximum integer that is not larger than a. For example, floor (1.5)=1.

Since one or more vertexes of a triangle may exist outside the display plane (which is not shown in FIG. 4), there is a need of clip operation. Given that the range of the display plane is defined by the clip window [clip_xmin, clip_xmax], [clip_ymin, clip_ymax], the clip operation is as follows:

if (xmin < clip_xmin) xmin = clip_xmin ;
if (ymin < clip_ymin) ymin = clip_ymin ;
if (xmax > clip_xmax) xmax = clip_xmax ;
if (ymax > clip_ymax) ymax = clip_ymax .

The clip operation gives the coordinates of pixels at the four corners of the bounding box of the triangle, that is, (xmin, ymin), (xmin, ymax), (xmax, ymin), (xmax, ymax), which define the bounding box.

Based on the edge functions of the triangle calculated by the edge function calculate block 301 and the bounding box of the triangle created by the bounding box create block 302, the traversal start pixel and traversal direction choose block 303 in the setup block 104 decides the traversal start pixel and the traversal direction.

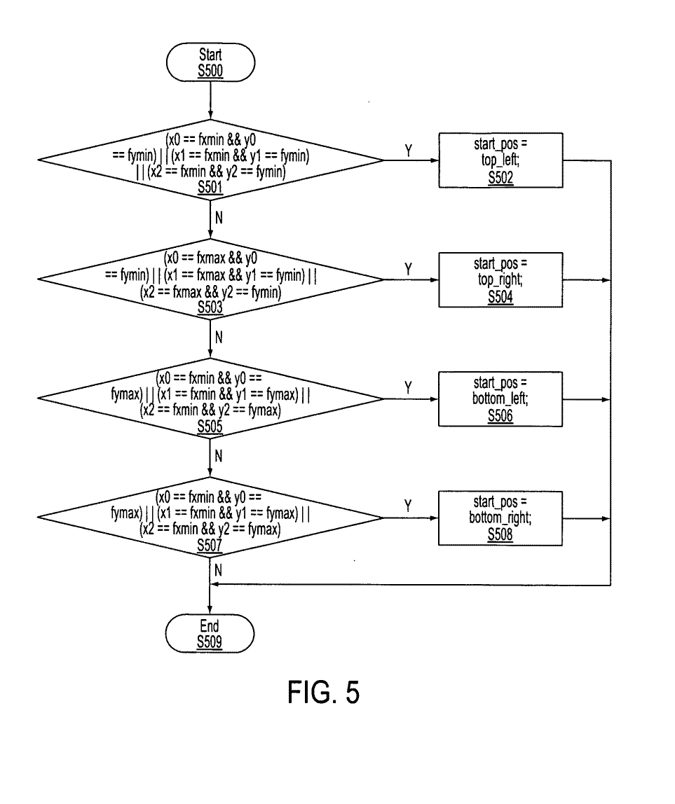

In particular, according to the process shown in FIG. 5, the traversal start pixel and traversal direction choose block 303 chooses a traversal start pixel from the pixels (xmin, ymin), (xmin, ymax), (xmax, ymin), (xmax, ymax) at the four corners calculated in the bounding box create block 302 by using the fxmin, fxmax, fymin and fymax received from the bounding box create block 302. The traversal start pixel is one of the pixels (xmin, ymin), (xmin, ymax), (xmax, ymin), (xmax, ymax) (that is, top_left, bottom_left, top_right, bottom_right) at the four corners of the bounding box of the triangle, which depends on the relationships between the coordinates of three vertex of the triangle and the coordinates of pixels at the four corners of the bounding box. The following codes show the choosing:

if ((x0 == fxmin && y0 == fymin) ∥ (x1 == fxmin && y1 ==

fymin) ∥ (x2 == fxmin && y2 == fymin)) start_pos = top_left (steps
S501 and S502);

else if ((x0 == fxmax && y0 == fymin) ∥ (x1 == fxmax && y1 ==

fymin) ∥ (x2 == fxmax && y2 == fymin)) start_pos = top_right (steps
S503 and S504);

else if ((x0 == fxmin && y0 == fymax) ∥ (x1 == fxmin && y1 ==

fymax) ∥ (x2 == fxmin && y2 == fymax)) start_pos = bottom_left (steps
S505 and S506);

else if ((x0 == fxmax && y0 == fymax) ∥ (x1 == fxmax && y1 ==

fymax) ∥ (x2 == fxmax && y2 == fymax)) start_pos = bottom_right
(steps S507 and S508).

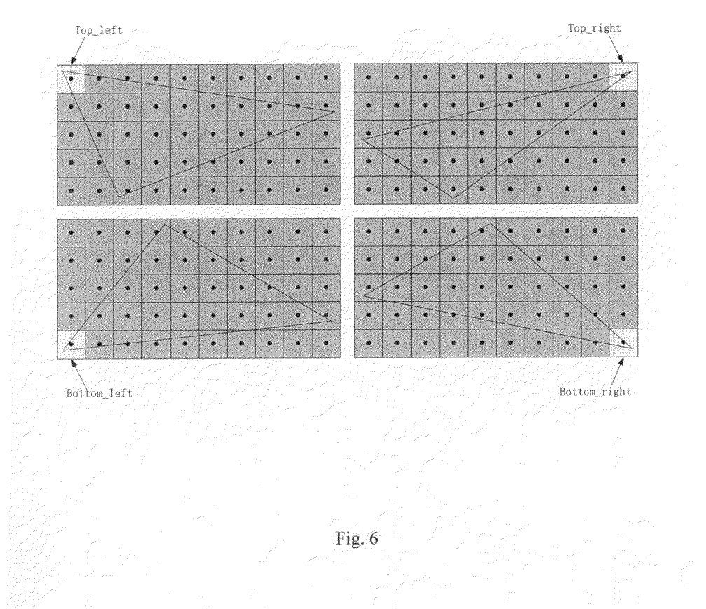

FIG. 6 shows the traversal start pixels each selected in one of four different cases. The (a), (b), (c) and (d) in FIG. 6 show the cases correspond to the branches S502, S504, S506 and S508 shown in FIG. 5, respectively.

Although FIG. 5 shows that the traversal start pixel is chosen in a certain order, i.e., top_left, top_right, bottom_left and bottom_left, the choosing can be performed in other orders. In addition, FIG. 6 shows a triangle as an example wherein only one vertex of the triangle falls within the pixel at one corner of the bounding box. However, it is possible that more than one vertexes of a triangle fall within pixels at corners of its bounding box.

As shown, there is at least one vertex of the triangle falling within a pixel at one corner of the bounding box before clip operation. If the bounding box is not subjected to a clip operation, the traversal start pixel is any one, within which a vertex of the triangle falls, among the pixels at the four corners of the bounding box. If the bounding box is subjected to a clip operation, the traversal start pixel is the one pixel at the corner corresponding to the corner where the traversal start pixel should be before the clip operation.

The traversal start pixel and traversal direction choose block 303 also chooses a traversal direction based on the coefficients of the edge functions received from the edge function calculate block 301 and the pixels (xmin, ymin), (xmin, ymax), (xmax, ymin) and (xmax, ymax) at the four corners of the bounding box. There are two possible traversal directions, that is, horizontal (line) and vertical (column) directions. If there is any pixel inside the triangle exists from the traversal start pixel in the horizontal line, the traversal direction should be horizontal; else the traversal direction should be vertical.

Based on the position of the traversal start pixel with respect to the triangle, it can be decided whether there is a pixel inside the triangle exists from the traversal start pixel in the line. The position of the traversal start pixel with respect to the triangle can be obtained from the values of the three edge functions of the triangle at the traversal start pixel. If a pixel is outside of a triangle, the values of the three edge functions at this pixel can be used to decide whether this pixel is in left/right/top/bottom of the triangle.

The following four equations are used to decide the position relationship of a pixel p(x,y) and a triangle:

| (1) InLeftTriangle(x, y) | |
|---|---|
| { | if ((e0(x,y) <0 && a0 >= 0) ∥ (e1(x,y) <0 && a1 >= 0) ∥ |

(e2(x,y) <0 && a2 >= 0))

return true;

| | else return false; |
|---|---|
| } | |
| (2) InRightTriangle(x, y) | |
| { | if ((e0(x,y) <0 && a0 <= 0) ∥ (e1(x,y) <0 && a1 <= 0) ∥ |

(e2(x,y) <0 && a2 <= 0))

return true;

| | else return false; |
|---|---|
| } | |
| (3)InTopTriangle (x, y) | |
| { | if ((e0(x,y) <0 && b0 <= 0) ∥ (e1(x,y) <0 && b1 <= 0) ∥ |

(e2(x,y) <0 && b2 <= 0))

return true;

else return false;

}
(4)InBottomTriangle (x, y)
{

if ((e0(x,y) <0 && b0 >= 0) ∥ (e1(x,y) <0 && b1 >= 0) ∥

(e2(x,y) <0 && b2 >= 0))

return true;

else return false;

}.

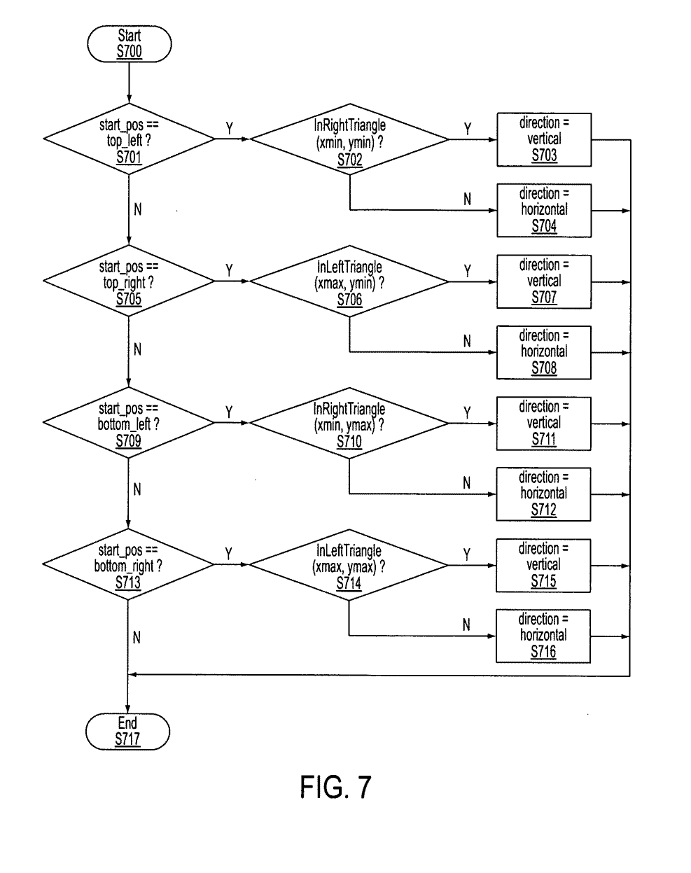

FIG. 7 is a flowchart showing a method for choosing the traversal direction. With respect to each different traversal start pixel, the method chooses a traversal direction based on the pixels at the four corners of the bounding box. The steps S701, S705, S709 and S713 shown in FIG. 7 illustrate four different cases of the traversal start pixel. The four branches S702-S704, S706-S708, S710-S712 and S714-S716 correspond to the above four different cases, respectively, and make decisions to obtain the traversal direction.

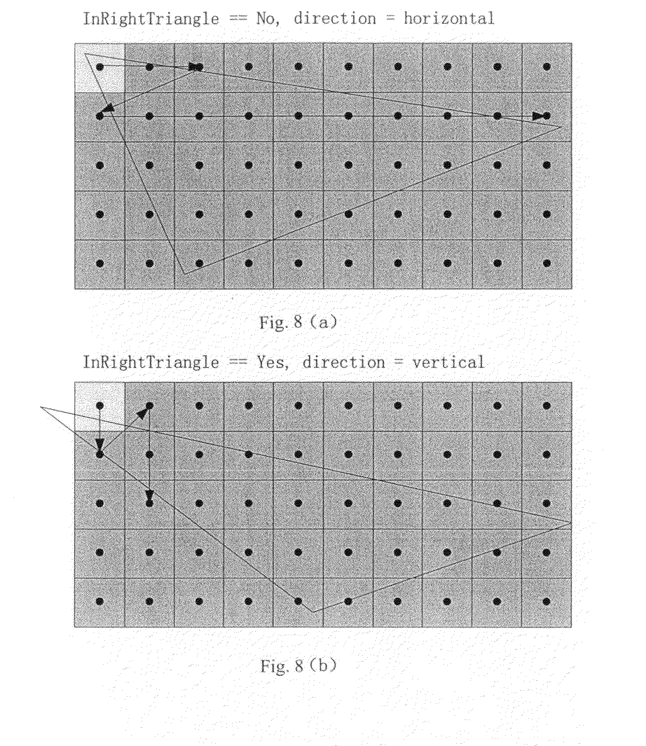

The (a) and (b) of FIG. 8 illustrate two different examples of the traversal direction, which are obtained by the process shown in FIG. 7. The (a) of FIG. 8 shows the traversal direction of horizontal by the steps S701, S702 and S704 shown in FIG. 7, while the (b) of FIG. 8 shows the traversal direction of vertical by the steps S701-S730 shown in FIG. 7.

The orders shown in FIG. 7 in which the traversal stat pixel is checked to choose the traversal direction and the illustrations shown in FIG. 8 are all exemplary. Different orders from those shown in FIG. 7 and different examples from those shown in FIG. 8 are possible.

At this time, the setup block 104 has calculated the edge functions, the traversal start pixel and the traversal direction. The traverse block 105 will traverse the triangle based on the information prepared by setup block 104.

The start pixel register block 304 in the traverse block 105 firstly receives the traversal start pixel from the traversal start pixel and traversal direction choose block 303 in the setup block 104, and registers it as current scan start pixel. The scan block 305 receives the current scan start pixel from the start pixel register block 304 and the traversal direction from the traversal start pixel and traversal direction choose block 303 in the setup block 104, and then scans the current line/column of the triangle from the current scan start pixel in the traversal direction. In the traversal, the scan start pixel in each line/column is adaptively adjusted so as not to visit pixels outside the triangle as much as possible, improving speed of the traversal.

In scan, the scan block 305 sends the scanned pixel to drawing judge block 307. The drawing judge block 307 decides whether the pixel is inside the triangle. If all values of the three edge functions of the triangle at the coordinate of the pixel are positive, it can be decided that the pixel is inside the triangle. The drawing judge block 307 sends the first pixel that is inside the triangle in the current line/column received from the scan block 305 to the next start pixel calculate block 306. If the current line/column there is no pixel that is inside the triangle, the traversal is ended and an instruction indicating end of the traversal is sent to the scan block 305.

The drawing judge block 307 also decides whether to end the scan of the current line/column with respect to each pixel p(x,y) received from the scan block 305. If the drawing judge block 307 decides not to end the scan of the current line/column, it sends the pixel p(x,y) to the parameter calculate block 308. If it decides to end the scan of the current line/column, it sends an instruction indicating end of the scan of the current line/column to the scan block 305.

If the pixel p(x,y) meets with one of the following conditions, the drawing judge block 307 decide to end the scan of the current line/column:

I. (start_pos = top_left ∥ start_pos = bottom_left) && (direction =

horizontal) && (InRightTriangle (x,y) = true);

II. (start_pos = top_right ∥ start_pos = bottom_right) && (direction

= horizontal) && (InLeftTriangle (x,y) = true);

III. (start_pos = top_left ∥ start_pos = top_right) && (direction =

vertical) && (InBottomTriangle (x,y) = true);

IV. (start_pos = bottom_left ∥ start_pos = bottom_right) &&

(direction = vertical) && (InTopTriangle (x,y) = true).

Every time receiving a pixel from the drawing judge block 307, the next start pixel calculate block 306 calculates the scan start pixel of the next line/column. The scan start pixel of the next line/column is determined adaptively based on the coefficients of edge functions. That is, the scan start pixel of the next line/column is obtained by calculating the distance between the first pixel that is inside the triangle in the current line/column and the one in the next line/column.

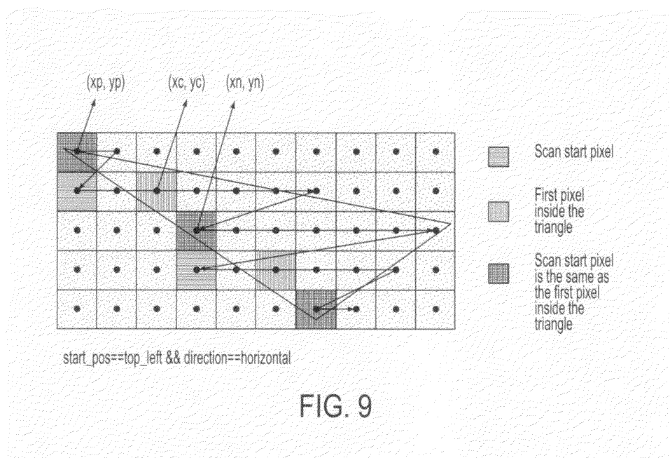

FIG. 9 is an example showing a complete traversal of a triangle, briefly illustrating how to choose the next scan pixel and the traversal method according the invention. In FIG. 9, the traversal start pixel is the top_left pixel and the traversal direction is horizontal direction. The traversal start pixel is also the scan start pixel in the first scan line. Let coordinate of the first pixel that is inside the triangle in the current line be (xc,yc) and the one in the previous line be (xp,yp), the scan start pixel (xn,yn) in the next line is calculated as follows:

delta_x = xc − xp −1;
delta_y = 1;
xn = xc + delta_x;
yn = yc + delta_y.

Likewise, as for a combination of a scan start pixel in different position with respect to a triangle and different traversal direction, the scan start pixel in the next line/column can be adaptively chosen by using the coefficients of edge functions.

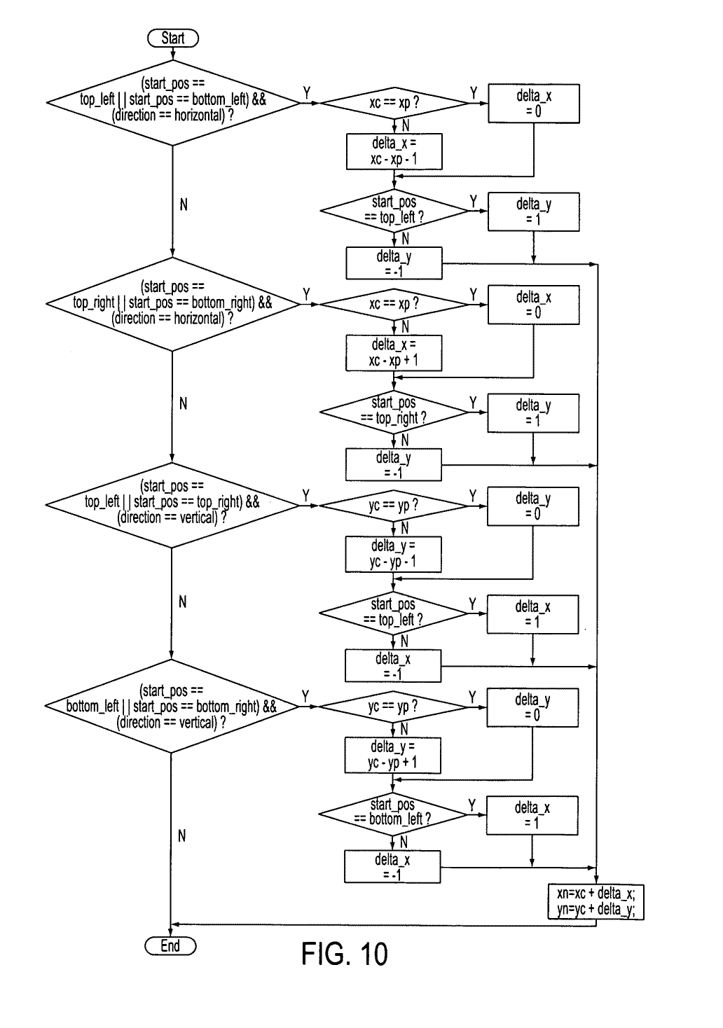

FIG. 10 is a flowchart showing how to calculate the scan start pixel in the next line/column. The four branches S1001-S1007, S1008-S1014, S1015-S1021 and S1022-S1027 shown in the figure are used to calculate the scan start pixel in the next line/column for four different combinations of the scan start pixel and the traversal direction, respectively.

As shown, if the traversal direction is horizontal, the delta_x is the distance between xc and xp. If xc=xp, the delta_x=0. Otherwise, the delta_x=|xc−xp|−1. The value of delta_y depends on whether the traversal start pixel is in the top line or the bottom line of the bounding box. If the traversal start pixel is in the top line, the delta_y=1. Otherwise, the delta_y=−1.

If the traversal direction is vertical, the delta_y is the distance between yc and yp. If yc=yp, the delta_y=0. Otherwise, the delta_y=|yc−yp|−1. The value of delta_x depends on whether the traversal start pixel is in the left column or the right column of the bounding box. If the traversal start pixel is in the left column, the delta_x=1. Otherwise, the delta_x=−1.

The order of the four branches shown in FIG. 10 is only exemplary. Other orders are possible.

In accordance with the above method, the next start pixel calculate block 306 calculates the scan start pixel in the next line/column, and sends it to the start pixel register block 304. The start pixel register block 304 registers the scan start pixel received from the next start pixel calculate block 306 as the current scan start pixel.

Upon receiving an instruction indicating end of the current line/column from the drawing judge block 307, the scan block 305 retrieves the current scan start pixel that was registered previously from the start pixel register block 304 and begins to scan the next line/column.

The scan process is repeated until the end of the traversal process.

For each pixel p(x,y) received from the drawing judge block 307, the parameter calculate block 308 calculates its parameters such as colour, texture, and sends the calculated parameters and the pixel to the frame buffer 106.

The prefer embodiments have been described above. Although the invention is described in specific embodiments, the invention can be implemented in hardware, software, firmware or a combination thereof, and applied to a system, subsystem and parts or subparts thereof. When implemented in software, the blocks of the invention are substantively code segments for accomplishing necessary works.

What is claimed is:

1. A method of traversing a triangle in graphic rasterization, comprising:
creating a bounding box which is the smallest rectangle consisting of pixels that covers the triangle;
choosing a traversal start pixel for traversing the triangle based on the bounding box;
choosing a traversal direction based on the position relation between the traversal start pixel and the triangle; and
traversing the triangle from the traversal start pixel in the traversal direction,
wherein traversing the triangle comprises calculating a next scan start pixel based on slope of a edge function of the triangle with respect to the traversal start pixel and the traversal direction.

2. The method of traversing a triangle of claim 1,'wherein,
if the bounding box was not subjected to a clip operation, the traversal start pixel is one corner pixel, in which a vertex of the triangle falls, among four corner pixels of the bounding box,
if the bounding box was subjected to a clip operation, the traversal start pixel is one corner pixel among four corner pixels of the bounding box that corresponds to one corner of the bounding box before the clip operation in which a vertex of the triangle falls.

3. The method of traversing a triangle of claim 1, wherein the traversal direction is the horizontal or vertical direction in which there is a pixel inside the triangle from the traversal start pixel.

4. The method of traversing a triangle of claim 1, traversing the triangle comprises finding the first pixel inside the triangle on the current line or column in the traversal direction.

5. The method of traversing a triangle of claim 4, wherein the next scan start pixel is derived by using the distance between the first pixels inside the triangle on the current line and the previous line or the distance between the first pixels inside the triangle on the current column and the previous column.

6. The method of traversing a triangle of claim 1, traversing the triangle further comprises deciding whether to end scan of the current line or column, wherein if the current pixel on the current line or column is outside the triangle while the previous pixel is inside the triangle, the scan of the current line or column is ended.

7. The method of traversing a triangle of claim 1, traversing the triangle further comprises ending the traversal of the triangle if there is no pixel inside the triangle in the traversal direction.

8. A device for traversing a triangle in graphic rasterization, comprising:
a bounding box creating block creating a bounding box which is the smallest rectangle consisting of pixels that covers the triangle;
a traversal start pixel choosing block choosing a traversal start pixel for traversing the triangle based on the bounding box;
a traversal direction choosing block choosing a traversal direction based on the position relation between the traversal start pixel and the triangle; and
a traverse block traversing the triangle from the traversal start pixel in the traversal direction,
wherein the traverse block traversing the triangle comprises means for calculating a next scan start pixel based on slopes of edge functions of the triangle with respect to the traversal start pixel and the traversal direction.

9. The device for traversing a triangle of claim 8, wherein,
if the bounding box was not subjected to a clip operation, the traversal start pixel is one corner pixel, in which a vertex of the triangle falls, among four corner pixels of the bounding box,
if the bounding box was subjected to a clip operation, the traversal start pixel is one corner pixel among four corner pixels of the bounding box that corresponds to one corner of the bounding box before the clip operation in which a vertex of the triangle falls.

10. The device for traversing a triangle of claim 8, wherein the traversal direction is the horizontal or vertical direction in which there is a pixel inside the triangle from the traversal start pixel.

11. The device for traversing a triangle of claim 8, the traverse block comprises means for finding the first pixel inside the triangle on the current line or column in the traversal direction.

12. The device for traversing a triangle of claim 11, wherein the next scan start pixel is derived by using the distance between the first pixels inside the triangle on the current line and the previous line or the distance between the first pixels inside the triangle on the current column and the previous column.

13. The device for traversing a triangle of claim 8, the traverse block further comprises means for deciding whether to end scan of the current line or column, wherein if the current pixel on the current line or column is outside the triangle while the previous pixel is inside the triangle, the scan of the current line or column is ended.

14. The device for traversing a triangle of claim 8, the traverse block further comprises means for ending the traversal of the triangle if there is no pixel inside the triangle in the traversal direction.

15. An apparatus for traversing a triangle in graphic rasterization, comprising:
a setup block that receives vertex coordinates of the triangle, calculates coefficients of edge functions of the triangle by using the
vertex coordinates, creates a bounding box of the triangle, chooses a traversal start pixel and a traversal direction; and
a traverse block that traverses the triangle based on the coefficients of edge functions, the traversal start pixel and the traversal direction,
wherein the traverse block calculates a next scan start pixel based on slope of a edge function of the triangle with respect to the traversal start pixel and the traversal direction.

16. The apparatus for traversing a triangle of claim 15, wherein the setup block comprises:
an edge function calculate block that calculates the coefficients of edge functions by using the vertex coordinates;
a bounding box create block that creates the bounding box which is the smallest rectangle consisting of pixels that covers the triangle by using the vertex coordinates; and
a traversal start pixel and traversal direction choose block that chooses the traversal start pixel for traversing the triangle based on the bounding box, and chooses the traversal direction based on the traversal start pixel and the coefficients of edge functions.

17. The apparatus for traversing a triangle of claim 16, wherein,
if the bounding box was not subjected to a clip operation, the traversal start pixel is one corner pixel, in which a vertex of the triangle falls, among four corner pixels of the bounding box,
if the bounding box was subjected to a clip operation, the traversal start pixel is one corner pixel among four corner pixels of the bounding box that corresponds to one corner of the bounding box before the clip operation in which a vertex of the triangle falls.

18. The apparatus for traversing a triangle of claim 16, wherein the traversal direction is the horizontal or vertical direction in which there is a pixel inside the triangle from the traversal start pixel.

19. The apparatus for traversing a triangle of claim 16, wherein the traverse block comprises a start pixel register block, a scan block, a next start pixel calculate block and a drawing judge block, wherein
the start pixel register block registers the traversal start pixel from the traversal start pixel and traversal direction choose block and the next scan start pixel from the next start pixel calculate block as scan start pixels;
the scan block receives a scan start pixel from the start pixel register block, the traversal direction from the traversal start pixel and traversal direction choose block, and an instruction for ending scan of the current line or column from the drawing judge block, and traverses the triangle,
sends the scanned pixel to the drawing judge block, and
receives an instruction for ending traversal of the triangle from the drawing judge block, and ends the traversal;
the next start pixel calculate block derives the next scan start pixel by using the distance between the first pixels inside the triangle on the current line and the previous line or the distance between the first pixels inside the triangle on the current column and the previous column; and
the drawing judge block receives the coefficients of edge functions from the edge function calculate block and the scanned pixel from the scan block, finds the first pixel inside the triangle on the current line or column in the traversal direction and sends it to the next start pixel calculate block,
judges whether to end scan of the current line or column, whether to end traversal of the triangle, and
judges whether to draw the scanned pixel.

20. The apparatus for traversing a triangle of claim 19, wherein the drawing judge block judges to end scan of the current line or column if the current pixel on the current line or column is outside the triangle while the previous pixel is inside the triangle.
